(19) United States
(12) Patent Application Publication
(10) Pub. No.: US 2010/0088915 A1
(43) Pub. Date: Apr. 15, 2010

(54) Measuring device and keepsake for recording pregnancy measurements and pregnancy experiences

(76) Inventor: Kevin Alexander Neff, Orlando, FL (US)

Correspondence Address: Kevin Alexander Neff, 1511 Roosevelt Avenue, Orlando, FL, 32804, US

(21) Appl. No.: 12/587,590

(22) Filed: Oct. 9, 2009

Related U.S. Application Data
(60) Provisional application No. 61/105,523, filed on Oct. 15, 2008.

(51) Int. Cl. G01B 3/10; G01B 1/00

(52) U.S. Cl. 33/759; 33/760; 33/771; 33/512

(57) ABSTRACT

A device and method for: accurately measuring a pregnant abdomen, recording and storing all pregnancy measurements, recording and storing pregnancy milestones and experiences, comparing one or more pregnancies, and creating a pregnancy keepsake. The invention includes a 1st side and 2nd side both comprising: a pliable strip; a measuring scale; a week's pregnant scale; a marking surface; a start clasp; and an end clasp. The invention permits an accurate measurement of both fundal height and pregnant abdominal circumference. The invention also accepts written documentation for marking all pregnancy measurements and pregnancy experiences. Additionally, a plurality of labels and pregnancy themed markers are provided for attachment to the invention in order to mark the current pregnancy measurements and pregnancy experiences.

This application claims priority date of provisional application No. 61/105,523.

### BACKGROUND OF INVENTION

Many women track the growth of their pregnant abdomen throughout the course of their pregnancy using a measuring tape. There are currently two common methods used for measuring a pregnant abdomen: fundal height and abdominal circumference. The measurement of a pregnant abdomen is taken by a doctor at every prenatal check-up. This form of measurement is known as a fundal height measurement and dates back to pre-ultrasound technology. A doctor will use a measuring tape to measure from the top of the pubic bone to the top of the uterus to see that the gestational age is compatible with the uterus size. A baby growing inside of the womb of a pregnant woman will have a fundal height measurement in centimeters that will match closely if not exactly with the amount of weeks the mother is pregnant. For example, a woman who is 33 weeks pregnant should have a fundal height measurement of 32-34 centimeters. Afterwards, the doctors will record the fundal height measurement in the patient's file and verbally tell the mother what her fundal height is currently measuring.

The other form of measurement of a pregnant woman's abdomen is the abdominal circumference. This form of measurement is used mainly as a reference for a pregnant woman since the actual measurement holds no medical indication of the progress of the pregnancy. To obtain this measurement, a measuring tape is wrapped around the back and then the front of the abdomen of the pregnant woman. The total inches of the abdominal circumference are either marked on the tape measure with a pen, or noted on a piece of paper.

One problem with using a tape measure for both of these measurements is that there is not enough space on a tape measure to adequately record the necessary information and statistics that go along with each type of measurement (i.e. date, number of weeks pregnant, and size), so the information must be transferred directly to a note pad, journal, computer, or the Internet. Different tape measures may also be used throughout the nine months of pregnancy, so actual marks made on one tape measure may become lost or discarded over the course of time. Also, because pregnancy statistics and measurements must be stored separately from the tape measure due to insufficient space, it becomes time consuming to refer back to a measurement to see just how big the abdomen was at a certain time during the pregnancy, or to compare two or more pregnancies together.

Many pregnant women also keep track and record their pregnancy experiences and milestones using a personal journal, word processing software, or the Internet. Although these methods are adequate for the recording of long descriptions and great details about the pregnancy, they are not practical for making quick references. It is time consuming to refer back to a specific time in the pregnancy in order to find out what they were experiencing; especially if they would like to compare their current pregnancy experiences with previous ones they have had or their family and friends have had.

Furthermore, if a woman would like to keep track of both her pregnancy measurements and pregnancy experiences in one location, she would be faced with an even more cumbersome and tedious task of recording all of the information so that it could be easily accessed for future reference. Again, it also becomes very difficult and time consuming to use this recorded pregnancy information to compare with previous or future pregnancies.

It is against this background that the present invention has been created. Accordingly, this invention aims to provide a means to achieve accurate fundal height and abdominal measurements of a pregnant woman; a means to record and store all of the pregnancy measurements; as well as a means to record and log all of the pregnancy milestones and experiences. Therefore, allowing a woman to have one place to essentially keep track of all of her pregnancy measurements and milestones. This invention will allow for easy reference to a previous pregnancy for comparing pregnancies and for creating a treasured keepsake of the pregnancy.

### SUMMARY OF INVENTION

The present invention is a measuring device and keepsake for recording pregnancy measurements and pregnancy experiences, which is made up of the following required elements: a pliable strip; a measuring scale; a marking surface; a start clasp and an end clasp. These elements are connected as follows: The start clasp is connected to the pliable strip at one end, while the end clasp is connected to the other opposite end of the pliable strip. A measuring scale is indicated across the top of the pliable strip extending from the start clasp to the end clasp, and is present on both the front and backside of the pliable strip. A marking surface is provided below the measuring scale on both front and back of the pliable strip.

Further, this invention can also have one or more of the following: pregnancy themed markers to be placed on the measuring scale to indicate a specific measurement taken; labels containing text and, or numbers indicating various dates (i.e. Mar. 23, 2008, 14 Weeks), pregnancy statistics (i.e. 145 lbs) and pregnancy experiences (i.e. Heard heart beat, 1st Ultrasound) to be placed on the marking surface; eyeholes centered and through both start and end clasps to allow for hanging and display of the pregnancy measurement and experience log with a nail or similar device; a weeks pregnant scale containing text and numbers indicating weeks of pregnancy (i.e. Week 1, Week 2, Week 42, etc) on the start end of the pliable strip; various birth statistic categories listed on the pliable strip, such as but not limited to Name, Date of Birth, Hospital, Height, Weight, Time of Delivery, Length of Labor, Doctor Delivering; lined space next to each birth statistic category to allow for the marking or writing of the information directly on the pliable strip.

It should further be noted that: the pliable strip can be made of various material that accepts writing or marks from a pencil, pen, marker, paint, ink, needle and thread, such as but not limited to vinyl, plastic, cloth, paper (or any other material of a flexible substrate that accepts writing), but vinyl is preferable; the start and end clasps can be made of various materials, such as but not limited to wood, plastic, aluminum steel, any other metal or metal alloy, or any other sufficiently resilient material, but metal is preferable; the start and end clasps can be connected to each end of the pliable strip by various means, such as but not limited to adhesive backing, glue, pins, clips, needle and thread, but glue is preferable; the pregnancy themed markers can be made of various materials such as but not limited to plastic, vinyl, paper, cloth, wood, metal, but vinyl is preferable; the pregnancy themed markers can be attached to the pliable strip by various means, such as but not limited to adhesive backing, pins, clips, needle and thread, but adhesive backing is preferable; the labels containing text and, or numbers can be made of various materials, such as but not limited to plastic, vinyl, paper, cloth, wood, metal, but vinyl is preferable; the labels containing text and, or numbers can be attached to the pliable strip by various means, such as but not limited to adhesive backing, pins, clips, needle and thread, but adhesive backing is preferable.

### BRIEF DESCRIPTION OF DRAWINGS

The invention may best be understood by reference to the following description taken in conjunction with the accompanying drawings in which:

FIG. 1 is a perspective view of the measuring device and keepsake for recording pregnancy measurements and pregnancy experiences

FIG. 2 is a cross-section side view of the start and end clasps of the invention.

FIG. 3 is a top view of the start and end clasps of the invention.

FIG. 4 is a top view of the start end of the invention depicting the pregnancy statistic categories, lined space, and the week's pregnant scale.

FIG. 5 is a top view of the end of the week's pregnant scale and the beginning of the measuring scale of the invention.

FIG. 6 is a top view of hand recording statistical and personal information about a pregnancy on the marking surface of the invention.

FIG. 7 is a top view of the end of the pregnancy measuring device and keepsake for recording pregnancy measurements and experiences.

FIG. 8 is a sketch illustrating the use of the invention to measure the abdominal circumference of a pregnant woman.

FIG. 9 is a sketch illustrating the use of the start clasp and marking point to indicate on the measuring scale an accurate abdominal circumference measurement.

FIG. 10 is a sketch illustrating the use of the invention to measure the fundal height of a pregnant woman.

### DETAILED DESCRIPTION OF EMBODIMENTS

The measuring device and keepsake for recording pregnancy measurements and pregnancy experiences is formed of a flexible material to allow the measuring device to be placed around a pregnant woman's back and abdomen for an accurate abdominal circumference measurement or to be placed on the top of the a pregnant abdomen for an accurate fundal height measurement. After an accurate measurement is taken, the measuring device and keepsake allows the user to write directly on its surface with conventional pens or pencils or mark with labels. The measuring device and keepsake has the advantage of being convenient to use, because it allows its users to do all of the following: accurately measure a pregnant abdomen throughout the course of a pregnancy; record and store all of the pregnancy measurements taken; record and store all of the different experiences and milestones of the pregnancy. Later, the measuring device and keepsake can be used to compare one or more pregnancies together and allows for easy reference to a previous pregnancy for comparing pregnancies, and for creating a treasured keepsake of the pregnancy.

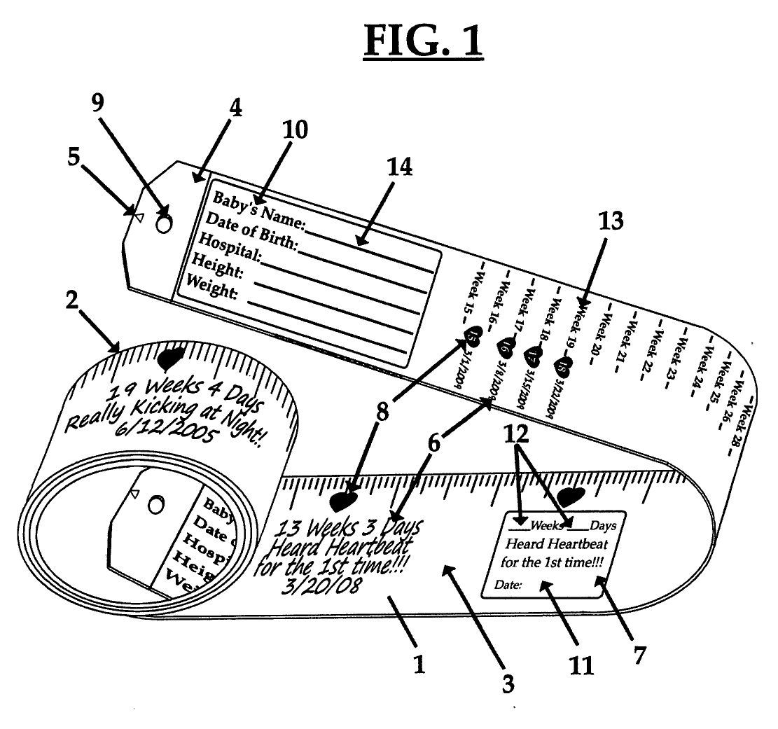

Referring now to the drawings in greater detail, FIG. 1 shows a perspective view of the measuring device and keepsake for recording pregnancy measurements and pregnancy experiences in a partially coiled position with the greater length of the pliable strip (1) coiled and the remaining portion slightly unraveling. The invention's pliability is such that it may be coiled up for ease of packaging for sale and storage when not being used for measuring and recording of pregnancy information. The invention may be of any desired length, but a length of 60″ is preferable. The invention contains a first and a second side with both sides containing identical embodiments. The invention is illustrated in FIG. 1 as including the following embodiments: a weeks pregnant scale (13) for obtaining accurate fundal height measurements; a measuring scale (2) for obtaining accurate abdominal circumference measurements; a marking surface (3) that accepts various forms of hand written marks (6) or labels placed directly onto the surface; pregnancy themed markers (8); labels (7) containing text and numbers; various birth statistic categories (10); a start end clasp (4); lined space (14) next to each birth statistic category to allow for the marking or writing of the information directly on the pliable strip; a marking point (5); an eyehole (9).

According to one embodiment, the pliable strip (1) is made of materials that accept writing or marks from a pencil, pen, marker, paint, ink, needle and thread, such as but not limited to vinyl, plastic, cloth, paper (or any other material of a flexible substrate that accepts writing), but vinyl is preferable.

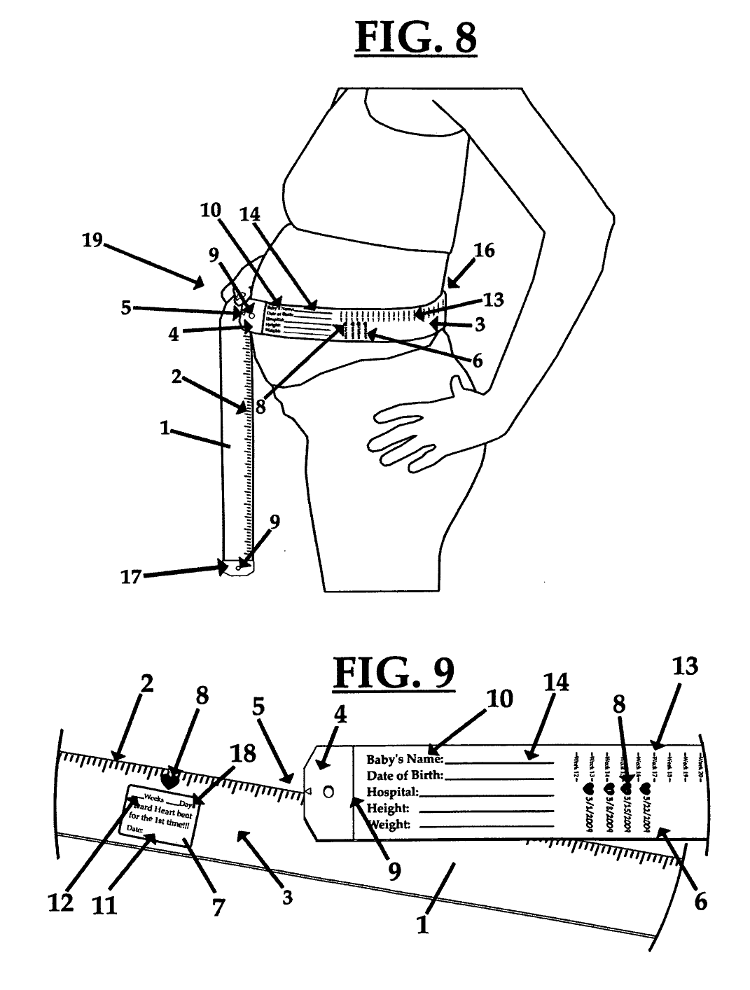

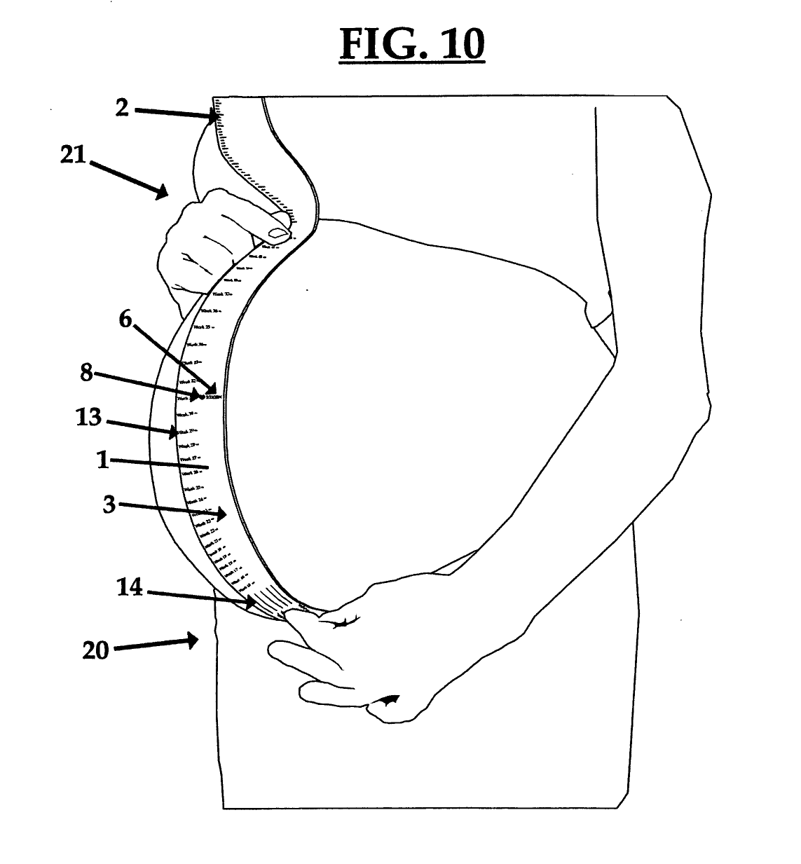

As best illustrated in FIG. 1, FIG. 8, and FIG. 9 the invention is preferably made of a pliable or flexible material that allows it to form to the body as it is wrapped around a pregnant woman's back (16) and abdomen (19) for measuring abdominal circumference. The pliable strip (1) is then overlapped at the widest point of the pregnant abdomen so that the start clasp (4) and marking point (5) may indicate an accurate abdominal circumference on the measuring scale (2). As shown in FIG. 10, the pliable material should also be flexible enough to allow it to form to the top of the pubic bone (20) and across the top of the pregnant abdomen to the top of the uterus (21) for an accurate fundal height measurement. In order to use the invention for this measurement the start end clasp (4) is placed firmly onto the pubic bone and the pliable strip (1) is laid across the top of the pregnant abdomen where the week's pregnant scale (13) is then pressed down onto the top of the uterus (21) so the fundal height may be measured. The fundal height measurement is then recorded below the week's pregnant scale (13) onto the marking surface (2) by a pregnancy themed marker (8) and hand written mark (6).

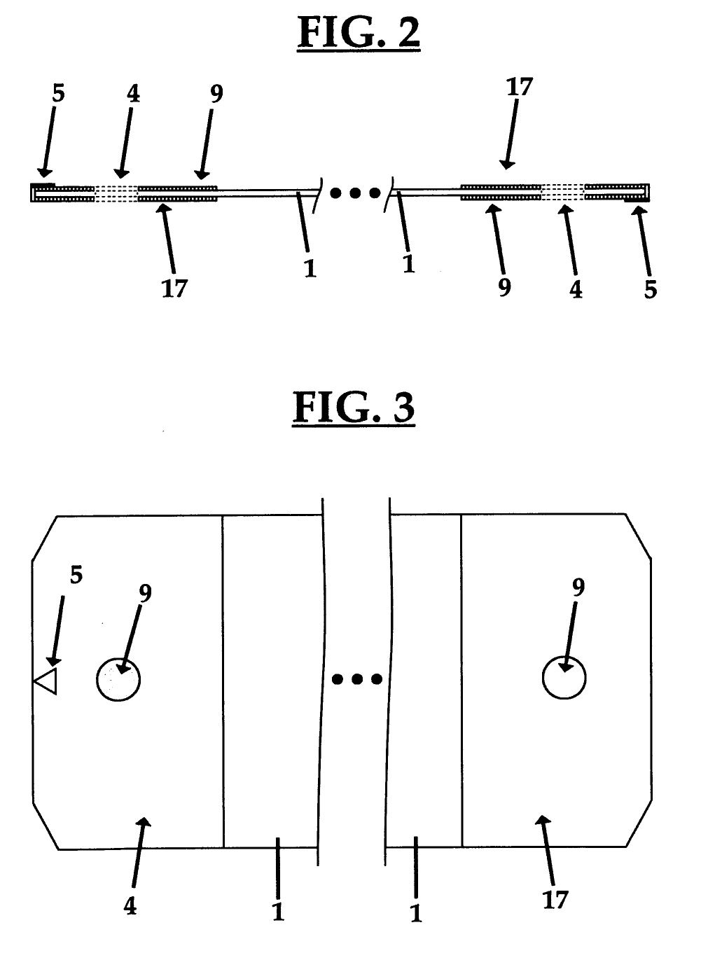

Referring now to FIG. 2 and FIG. 3 of the drawings, the invention contains both a start clasp (4) and an end clasp (17). Connected to the backside of the start clasp is the end clasp (17), therefore allowing for the invention to have two sides that are identical. The clasps are attached to each end of the pliable strip (1) with the start clasp (4) side present on the start end of the (1) pliable strip and the end clasp (16) side present on the end of the pliable strip (1). The start clasp (4) side contains a marking point (5) and an eyehole (9). It should be noted that the start clasp (4) can be made in various shapes and designs and of various materials. The eyehole (9) is centered and through the clasp to allow for hanging and display with a nail or similar device. The end clasp (17) side also contains the same (9) eyehole, as the start clasp (4), that is centered and through the clasp to allow for hanging and display with a nail or similar device.

As shown in FIG. 9 of the drawings, the invention contains a marking point (5) located on the start clasp (4). The marking point (5) is used to indicate the exact measurement of the abdominal circumference when the pliable strip (1) is overlapped at the widest point of the pregnant abdomen.

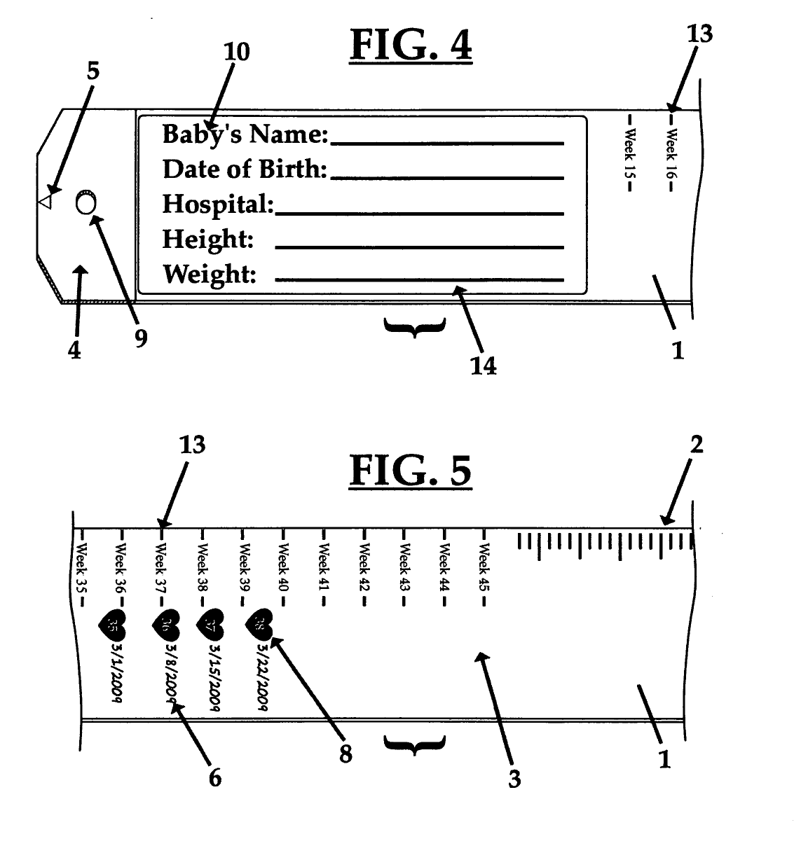

Referring now to FIG. 4 and FIG. 5 of the drawings, the invention contains various birth statistic categories (10) and lined space (14) directly next to each category for the recording of the pregnancy's final statistical information. These statistical categories are located next to the start clasp (4). The information for each statistic can be hand written or marked by label after the birth of the baby being tracked. Also included in this illustration, is the weeks pregnant scale (13) located on the start end of the (1) pliable strip. The scale starts with a mark indicating “Week 15” and continues up through “Week 42”. It should be noted that the weeks pregnant scale (13) can start and end with various week numbers, but Week 15 thru 42 are preferable. Each of the weeks pregnant scale (13) marks are spaced one centimeter apart from the next, so to allow for an accurate measurement of the current fundal height. Once the fundal height measurement has been taken a pregnancy themed marker (8) is placed at the current measurement. It should be noted that the pregnancy themed marker (8) will have a variety of shapes and may contain various numbers or letters on the embodiment so to indicate a specific date or size. In FIG. 5, the pregnancy themed markers (8) are shaped like a heart and contain numbers that represent the current weeks in the pregnancy. Also, present in this illustration is the start of the measuring scale (2). The scale starts after the last weeks pregnant scale (13) marker of “Week 42”, and is located on the top ¼ of the pliable strip (1) extending the length of the invention from end to end. The scale can be of various measurements, but inches are preferable. As previous noted, the length of the scale can extend to various lengths, but a length of 60″ is preferable.

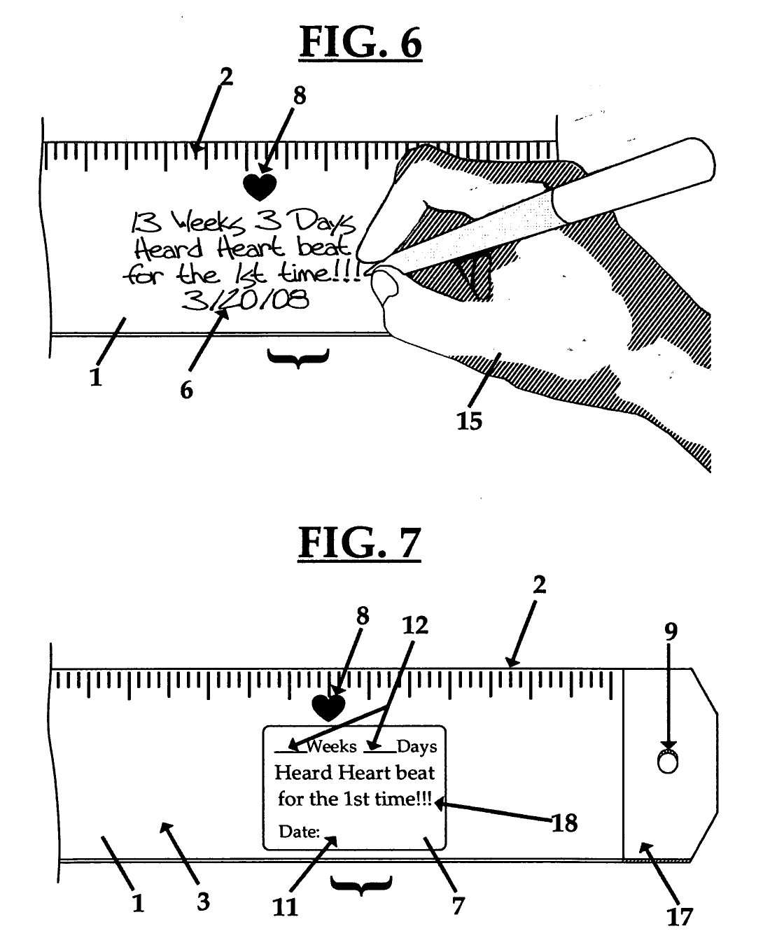

Referring now to FIG. 4, FIG. 5 of the drawings, the invention contains a marking surface (3) below both the week's pregnant scale (13) and the measuring scale (2). The marking surface extends the entire length of the pliable strip (1) from end to end, and extends ¾ of the (1) pliable strip from bottom to top. The marking surface (3) as illustrated best in FIG. 6 accepts written marks (6) directly on the surface from various items such as but not limited to pencil, pen, marker, paint, and ink. Therefore, allowing for easy and convenient recording by hand (15) of each pregnancy measurement and statistic, as well as, the documentation of current experiences and milestones of the pregnancy at each particular measurement.

Referring now to FIG. 7 of the drawings, the invention also contains a plurality of marking labels (7) containing a variety of different text and, or numbers indicating various dates in the pregnancy (i.e. Mar. 23, 2008, 14 Weeks and 3 Days, Week 34). The labels, as shown in FIG. 7 and FIG. 1, are indicative of, but not limited to, the following pre-printed pregnancy experiences (18): “Heard heart beat for the 1st time”, “1st Ultrasound”, “Baby is really kicking”, “3D Ultrasound”, “Feeling contractions”. Space is also provided on the labels for either hand written or labeled information to be added to the surface of the label. Space provided is for entering the number of weeks and days (12) of the pregnancy at the time of the measurement being taken, as well as, the current date (11) of pregnancy and measurement being taken. In various embodiments, the (7) marking labels are made of the following, such as but not limited to plastic, vinyl, paper, cloth, wood, metal, but vinyl is preferable.

What is claimed is:

1. THE EMBODIMENTS OF THE INVENTION IN WHICH AN EXCLUSIVE PROPERTY OR PRIVILEGE IS CLAIMED ARE DEFINED AS FOLLOWS: A pregnancy measurement and experience log with a 1st side and 2nd side both comprising: 1) a pliable strip (2) a measuring scale (3) a marking surface (4) a start clasp and (5) an end clasp.

2. The invention of claim 1, wherein the pliable strip comprises one of the following materials: such as but not limited to vinyl, plastic, cloth, paper (or any other material of a flexible substrate), but vinyl is preferable.

3. The invention of claim 2, wherein the material accepts writing or marks from a pencil, pen, marker, paint, ink, needle and thread.

4. The invention of claim 1, wherein a measuring scale runs the top ¼ of the pliable strip from end to end.

5. The invention of claim 4, wherein the measuring scale is attached to the pliable strip by using one of the following attachment mechanisms, such as but not limited to sewing, Velcro®, gluing, printing, or painting.

6. The invention of claim 4, wherein the measuring scale comprises, such as but not limited to inch and centimeter marks.

7. The invention of claim 6, wherein the inch and centimeter marks are attached to the pliable strip by using one of the following attachment mechanisms: sewing, Velcro®, Gluing, printing, or painting.

8. The invention of claim 4, wherein the measuring scale comprises numerals indicating the centimeter and inch marks.

9. The invention of claim 8, wherein the numerals indicating the centimeter and inch marks are attached to the pliable strip by using one of the following attachment mechanisms: sewing, Velcro®, gluing, printing, or painting.

10. The invention of claim 4, wherein the measuring scale comprises text indicting each week of pregnancy next to each centimeter mark (i.e. Week 1 located next to the 1 cm thru Week 42 located next to the 42 cm mark).

11. The invention of claim 10, wherein the text indicting each week of pregnancy next to each centimeter mark are attached to the pliable strip by using one of the following attachment mechanisms, such as but not limited to sewing, Velcro®, gluing, printing, or painting.

12. The invention of claim 4, wherein the measuring scale accepts a plurality of pregnancy themed markers to be placed on the measuring scale to indicate a specific measurement taken of the pregnancy.

13. The invention of claim 12, wherein a plurality of pregnancy themed markers are attached to the measuring scale by using one of the following attachment mechanisms, such as but not limited to sewing, Velcro®, gluing, adhesive backing, printing, or painting.

14. The invention of claim 12, wherein the plurality of pregnancy themed markers represent various pregnancy themed shapes, such as but not limited to a heart, baby rattle, stork, flower, sun, pacifier, safety pin, bottle, rubber duck, baby stroller, or any other baby themed object.

15. The invention of claim 14, where in the pregnancy themed markers are configured so to be attached to the measuring scale at each pregnancy measurement to specifically mark each measurement taken by one of the following mechanisms, such as but not limited to sewing, Velcro®, gluing, adhesive backing, printing, or painting.

16. The invention of claim 2, wherein the pliable strip contains birth statistic categories located at the start end, such as but not limited to Name, Date of Birth, Hospital, Height, Weight, Time of Delivery, Length of Labor, Doctor Delivering.

17. The invention of claim 16, wherein the birth statistic categories are attached to the pliable strip by using one of the following attachment mechanisms, such as but not limited to sewing, Velcro®, gluing, adhesive backing, printing, or painting.

18. The invention of claim 16 further consists of lined space next to each birth statistic category to allow for the marking or writing of the information directly on the pliable strip.

19. The invention of claim 1, wherein a marking surface runs the bottom ¾ of the pliable strip from end to end.

20. The invention of claim 19, wherein the marking surface accepts writing or marks from a pencil, pen, marker, paint, ink, clips, needle and thread, magnet backing, adhesive backing, or any other marking material for marking and recording pregnancy measurements, pregnancy statistics and pregnancy experiences.

21. The invention of claim 19, wherein the marking surface accepts a plurality of labels.

22. The invention of claim 21, wherein the plurality of labels contain text and, or numbers indicating various dates in the pregnancy (i.e. Mar. 23, 2008, 14 Weeks and 3 Days, Week 34).

23. The invention of claim 21, wherein the plurality of labels are indicative of, but not limited to, the following pregnancy statistics and experiences such as but not limited to days, weeks, and months of pregnancy, current body weight; circumference of pregnant abdomen and fundal height; “Heard heart beat for the 1st time”, “1st Ultrasound”, “Baby is really kicking”, “3D Ultrasound”.

24. The invention of claim 21, wherein the plurality of labels are made from one of the following, such as but not limited to plastic, vinyl, paper, cloth, wood, metal, but vinyl is preferable.

25. The invention of claim 21, wherein the plurality of labels accept writing or marks from a pencil, pen, marker; paint, ink, clips, needle and thread, magnet backing, adhesive backing, or any other marking material.

26. The invention of claim 21, wherein the plurality of labels further consists of lined space to allow for the marking or writing of the information directly on the labels.

27. The invention of claim 21, wherein the plurality of labels are to be attached to the marking surface by one of the following mechanisms, such as but not limited to sewing, Velcro®, gluing, adhesive backing, magnetic backing, printing, or painting.

28. The invention of claim 1, wherein the start clasp comprises one of the following materials, such as but not limited to wood, plastic, aluminum steel, any other metal or metal alloy, or any other sufficiently resilient material, but metal is preferable.

29. The invention of claim 28, wherein the start clasp is to be attached to the start end of the pliable strip by one of the following mechanisms, such as but not limited to sewing, Velcro®, gluing, adhesive backing, clamping, printing, or painting.

30. The invention of claim 28, wherein the start clasp includes a marking point to indicate the exact pregnancy measurement when over lapping the measuring scale.

31. The invention of claim 30, wherein the marking point is attached to the start end clasp by one of the following mechanisms, such as but not limited to embossing, engraving, sewing, Velcro®, gluing, adhesive backing, printing, or painting.

32. The invention of claim 30, wherein the marking point is shaped as one of the following shapes, such as but not limited to an arrow, triangle, cross, circle, or star.

33. The invention of claim 28, wherein the start clasp comprises an eyehole centered and through the clasp to allow for hanging and display with a nail or similar device.

34. The invention of claim 1, wherein the end clasp comprises one of the following materials, such as but not limited to wood, plastic, aluminum steel, any other metal or metal alloy, or any other sufficiently resilient material, but metal is preferable.

35. The invention of claim 34, wherein the end clasp is to be attached to the end of the pliable strip by one of the following mechanisms, such as but not limited to sewing, Velcro®, gluing, adhesive backing, clamping, printing, or painting.

36. The invention of claim 34, wherein the end clasp comprises an eyehole centered and through the clasp to allow for hanging and display with a nail or similar device.

37. The invention of claim 1, wherein the pliable strip contains a week's pregnant scale located at the start end.

38. The invention of claim 37, wherein the weeks pregnant scale is attached to the pliable strip by using one of the following attachment mechanisms, such as but not limited to sewing, Velcro®, gluing, adhesive backing, printing, or painting.

39. The invention of claim 37, wherein the week's pregnant scale contains a variety of text, such as but not limited to “Week 1”, “Week 2”, or “Week Forty”.

40. The invention of claim 39, wherein the weeks pregnant scale contains marks next to the text, such as but not limited to dashes, dots, lines, circles, etc.

41. The invention of claim 39, wherein the variety of text is spaced apart at one centimeter from each other.

42. The invention of claim 40, wherein the marks next to the variety of text is spaced apart at one centimeter from each other.
